(19) United States
(12) Patent Application Publication
(10) Pub. No.: US 2017/0009790 A1
(43) Pub. Date: Jan. 12, 2017

(54) RESILIENT FASTENER

(71) Applicant: FIVETECH TECHNOLOGY INC., NEW TAIPEI CITY (TW)

(72) Inventor: TING-JUI WANG, NEW TAIPEI CITY (TW)

(21) Appl. No.: 15/200,649

(22) Filed: Jul. 1, 2016

(30) Foreign Application Priority Data
Jul. 6, 2015 (TW) 104210910

(51) Int. Cl. F16B 5/06

(52) U.S. Cl. CPC F16B 5/0642

(57) ABSTRACT

A resilient fastener couples to a first object and fastened to a second object, including a body portion coupled to the first object and having a mounting portion; a resilient fastening portion integrally or compositely formed at the body portion and protruded from the body portion to get fastened to the second object; and an elastic portion disposed at the mounting portion and adapted to exert an elastic force on the resilient fastening portion pushed resiliently by the elastic portion when the resilient fastening portion is compressed. Accordingly, the resilient fastener penetrates the second object with the body portion such that the resilient fastening portion is quickly fastened to the second object.

### CROSS-REFERENCE TO RELATED APPLICATION

This non-provisional application claims priority under 35 U.S.C. §119 (a) on Patent Application No. 104210910 filed in Taiwan (R.O.C.) on Jul. 6, 2015, and the entire contents of which are hereby incorporated by reference.

### FIELD OF THE INVENTION

The present invention relates to resilient fasteners and, more particularly, to a resilient fastener coupled to a first object and quickly fastened to a second object.

### BACKGROUND OF THE INVENTION

A conventional fixing component for connecting two plate elements usually adopts screw-based fastening technology whose specific embodiment requires that the fixing component comprises a screw and a sleeve. A force-applied portion with a drive is disposed at one end of the screw. A body connected to the force-applied portion is disposed at the other end of the screw. The sleeve fits around the body of the screw such that the screw is movable within the sleeve. The fixing component is characterized in that: one end of the sleeve is coupled to a first object, such as a circuit board; the body of the screw penetrates the sleeve from one end thereof and corresponds in position to a screw hole of a second object, such as a chassis or a casing, and then a tool exerts a rotational force on the drive of the force-applied portion of the screw, such that the body is fastened to the screw hole of the second object, thereby connecting the first object and the second object. However, the conventional fixing component takes time to operate, and thus the two objects cannot be quickly connected or separated. Furthermore, the operation of the conventional fixing component requires a tool. Accordingly, it is important to provide a resilient fastener whereby two objects are quickly connected and separated by performing pressing and fastening operations thereon without any tool.

### SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a resilient fastener as disclosed in the present invention to fasten two objects together quickly without any tool.

In order to achieve the above and other objectives, the present invention provides a resilient fastener, coupled to a first object and fastened to a second object, comprising: a body portion coupled to the first object and having a mounting portion; a resilient fastening portion integrally or compositely formed at the body portion and protruded from the body portion to get fastened to the second object; and an elastic portion disposed at the mounting portion and adapted to exert an elastic force on the resilient fastening portion pushed resiliently by the elastic portion when the resilient fastening portion is compressed.

The body portion is a post, a rod, a plate, or a polyhedron, and the mounting portion is a receiving opening parallel to, perpendicular to, not parallel to, not perpendicular to, longitudinal relative to, or transverse relative to the post, the rod, the plate, or the polyhedron, respectively.

The resilient fastening portion has a resilient fastening unit integrally formed with the body portion, with the resilient fastening portion formed on an outer surface of the resilient fastening unit.

The resilient fastening portion has a resilient fastening surface, with the resilient fastening surface being a spherical surface, an elliptic surface, a curved surface, an oblique surface, or a polygonal surface.

The resilient fastening portion is a sphere, a hemisphere, an ellipse, an arcuate solid, a post, a polyhedron, a protruding portion, or a concave portion.

The elastic portion is an elastic component, and the elastic component is a spiral spring, a leaf spring, a resilient post, or a bent spring.

The elastic portion has a restrictive fastening portion coupled to the body portion, the mounting portion, or a corresponding fastening portion of the mounting portion.

The mounting portion has stop portions for restricting the elastic portion.

The stop portions are disposed at one end, two ends, an upper end, a lower end or a lateral side of the elastic portion.

The resilient fastener comprises a coupling portion integrally or compositely formed at the body portion and coupled to the first object through posting, riveting, screwing, expanding, welding, fastening, adhering, magnetic attraction, surface-mount technology (SMT), or integral forming.

The resilient fastener is coupled to the first object to form a module.

The resilient fastener comprises a sleeve movably fitted around or confined to the body portion and coupled to the first object.

The resilient fastener comprises a sleeve of a cap movably fitted around the body portion or confined to the body portion, with the sleeve coupled to the first object.

The resilient fastener comprises a sleeve movably fitted around or confined to the body portion, and a wrench disposed outside the sleeve to pivotally connect with the body portion or abut against the sleeve, with the sleeve coupled to the first object, wherein a distance from a point of pivotal connection between the wrench and the body portion to an abutting end surface of the wrench differs from or equals a distance from the point of pivotal connection between the wrench and the body portion to an abutting lateral surface of the wrench.

The mounting portion is disposed outside the body portion, and the resilient fastening portion is movably disposed outside the body portion.

In order to achieve the above and other objectives, the present invention provides a resilient fastener, coupled to a first object and fastened to a second object, comprising: a body portion coupled to the first object and having a mounting portion; an elastic portion mounted on the mounting portion and having an end provided with a resilient fastening portion, wherein, to be fastened to the second object, the resilient fastening portion protrudes from the body portion by being compressed and thus resiliently pushed by the elastic portion.

The body portion is a post, a rod, a plate, or a polyhedron, and the mounting portion is a receiving opening parallel to, perpendicular to, not parallel to, not perpendicular to, longitudinal relative to, or transverse relative to the post, the rod, the plate, or the polyhedron, respectively.

The receiving opening or the body portion has at least one restrictive portion protruding from or retracting into an inner wall or an opening of the receiving opening to restrict the elastic portion or the resilient fastening portion.

The mounting portion comprises a first receiving opening parallel to the body portion and at least one second receiving opening extending from a side of the body portion to radially communicate with the first receiving opening, wherein the elastic portion is disposed at the first receiving opening, and the resilient fastening portion is disposed at the second receiving opening.

The elastic portion is a standalone elastic component, and the resilient fastening portion is a standalone fastener.

The elastic portion and the resilient fastening portion are integrally formed to become a standalone component.

The elastic portion is an elastic component. The elastic component is a spiral spring, a leaf spring, a resilient post, or a bent spring.

The resilient fastening portion has a resilient fastening surface. The resilient fastening surface is a spherical surface, an elliptic surface, a curved surface, an oblique surface, or a polygonal surface.

The resilient fastening portion is a sphere, a hemisphere, an ellipse, an arcuate solid, a post, a polyhedron, a protruding portion, or a concave portion.

The elastic portion has a restrictive fastening portion coupled to the body portion or the mounting portion.

The resilient fastener comprises a coupling portion integrally or compositely formed at the body portion and coupled to the first object through posting, riveting, screwing, expanding, welding, fastening, adhering, magnetic attraction, surface-mount technology (SMT), or integral forming.

The resilient fastener is coupled to the first object to form a module.

The resilient fastening portion has a fixing portion positioned at and coupled to the elastic portion.

The fixing portion is coupled to the elastic portion through posting, riveting, screwing, expanding, welding, fastening, adhering, magnetic attraction, surface-mount technology (SMT), or integral forming.

The fixing portion has a through-hole, a sleeve, a post, a fastener, a step portion, or a plane portion.

The resilient fastener comprises a sleeve movably fitted around or confined to the body portion and coupled to the first object.

The resilient fastener comprises a sleeve of a cap movably fitted around the body portion or confined to the body portion, with the sleeve coupled to the first object.

The resilient fastener comprises a sleeve movably fitted around or confined to the body portion, and a wrench disposed outside the sleeve to pivotally connect with the body portion or abut against the sleeve, with the sleeve coupled to the first object, wherein a distance from a point of pivotal connection between the wrench and the body portion to an abutting end surface of the wrench differs from or equals a distance from the point of pivotal connection between the wrench and the body portion to an abutting lateral surface of the wrench.

Accordingly, according to the present invention, the resilient fastener can be coupled to a first object, such as a casing, chassis, plate or circuit board, and fastened to a second object, such as another casing, chassis, plate or circuit board, so as to fasten two objects together quickly.

### BRIEF DESCRIPTION OF THE DRAWINGS

Objectives, features, and advantages of the present invention are hereunder illustrated with specific embodiments in conjunction with the accompanying drawings, in which:

FIG. 1 is a cross-sectional view of an assembled resilient fastener according to the first specific embodiment of the present invention;

FIG. 2 is a top view of the resilient fastener of FIG. 1 in a specific embodiment;

FIG. 3 is a schematic view of the fastening operation of the resilient fastener of FIG. 1 in a specific embodiment;

FIG. 4 is a schematic view of the fastening state of the resilient fastener of FIG. 1 in a specific embodiment;

FIG. 5 is a schematic view of a riveting structure for the resilient fastener according to the first specific embodiment of the present invention;

FIG. 6 is a schematic view of a screwing structure for the resilient fastener according to the first specific embodiment of the present invention;

FIG. 7 is a schematic view of two stop portions of the resilient fastener according to the first specific embodiment of the present invention;

FIG. 8 is a cross-sectional view of an assembled resilient fastener according to the second specific embodiment of the present invention;

FIG. 9 is a schematic view of a resilient post for the resilient fastener according to the second specific embodiment of the present invention;

FIG. 10 is a schematic view of a leaf spring and a welding structure for the resilient fastener according to the second specific embodiment of the present invention;

FIG. 11 is a schematic view of the leaf spring and fastening structure for the resilient fastener according to the second specific embodiment of the present invention;

FIG. 12 is a schematic view of resilient fastening units for the resilient fastener according to the second specific embodiment of the present invention;

FIG. 13 is a cross-sectional view of effectuating resilient fastening with reference to FIG. 12;

FIG. 14 is a schematic view of the fastening operation of the resilient fastener of FIG. 12 in a specific embodiment;

FIG. 15 is a schematic view of the fastening state of the resilient fastener of FIG. 12 in a specific embodiment;

FIG. 16 is a schematic view of a single resilient fastening unit for the resilient fastener according to the second specific embodiment of the present invention;

FIG. 17 is a schematic view of resilient fastening units for the resilient fastener according to the second specific embodiment of the present invention;

FIG. 18 is a schematic view of a body portion movably coupled to a sleeve of the resilient fastener according to the second specific embodiment of the present invention;

FIG. 19 is a schematic view which shows that the cap of the body portion is movably coupled to the sleeve according to the second specific embodiment of the present invention;

FIG. 20 is a schematic view of the body portion movably coupled to the sleeve and a wrench according to the second specific embodiment of the present invention;

FIG. 21 is a schematic view 2 of a single resilient fastening unit for the resilient fastener according to the second specific embodiment of the present invention;

FIG. 22 is a schematic view 3 of a single resilient fastening unit for the resilient fastener according to the second specific embodiment of the present invention;

FIG. 23 is a schematic view which shows that the resilient mass and the resilient fastening unit are integrally formed according to the second specific embodiment of the present invention;

FIG. 24 is a schematic view of the fastening operation of the resilient fastener of FIG. 23 in a specific embodiment;

FIG. 25 is a schematic view of the fastening state of the resilient fastener of FIG. 23 in a specific embodiment;

FIG. 26 is a schematic view of the leaf spring for the resilient fastener according to the second specific embodiment of the present invention;

FIG. 27 is a schematic view of a resilient post for the resilient fastener according to the second specific embodiment of the present invention;

FIG. 28 is a schematic view of a restrictive fastening portion and a corresponding fastening portion of the resilient fastener according to the second specific embodiment of the present invention;

FIG. 29 is a schematic view which shows that the body portion has a restrictive portion disposed at an opening end of a receiving opening according to the second specific embodiment of the present invention;

FIG. 30 is a schematic view of the body portion movably coupled to the sleeve when a resilient mass and a resilient fastening unit are integrally formed according to the second specific embodiment of the present invention;

FIG. 31 is a schematic view which shows that a cap of the body portion is movably to the sleeve when the resilient mass and the resilient fastening unit are integrally formed according to the second specific embodiment of the present invention;

FIG. 32 is a schematic view of the body portion movably coupled to the sleeve and the wrench when the resilient mass and the resilient fastening unit are integrally formed according to the second specific embodiment of the present invention;

FIG. 33 is a schematic view which shows that body portion has a restrictive portion disposed at an opening end of a receiving opening according to the second specific embodiment of the present invention;

FIG. 34 is a schematic view which shows that the resilient fastening portion has a fixing portion and an elastic portion coupled thereto according to the second specific embodiment of the present invention;

FIG. 35 is a schematic view which shows that the resilient fastening portion has a fixing portion according to the second specific embodiment of the present invention;

FIG. 36 is a schematic view of the first step of the method of manufacturing the restrictive portion according to the present invention; and

FIG. 37 is a schematic view of the second step of the method of manufacturing the restrictive portion according to the present invention.

### DETAILED DESCRIPTION OF THE PREFERRED EMBODIMENTS

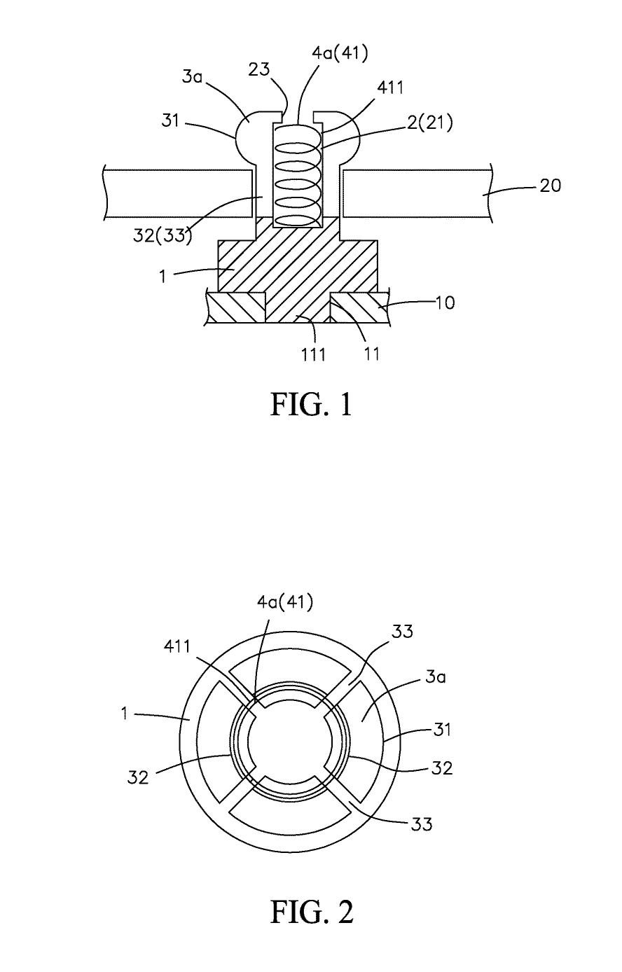

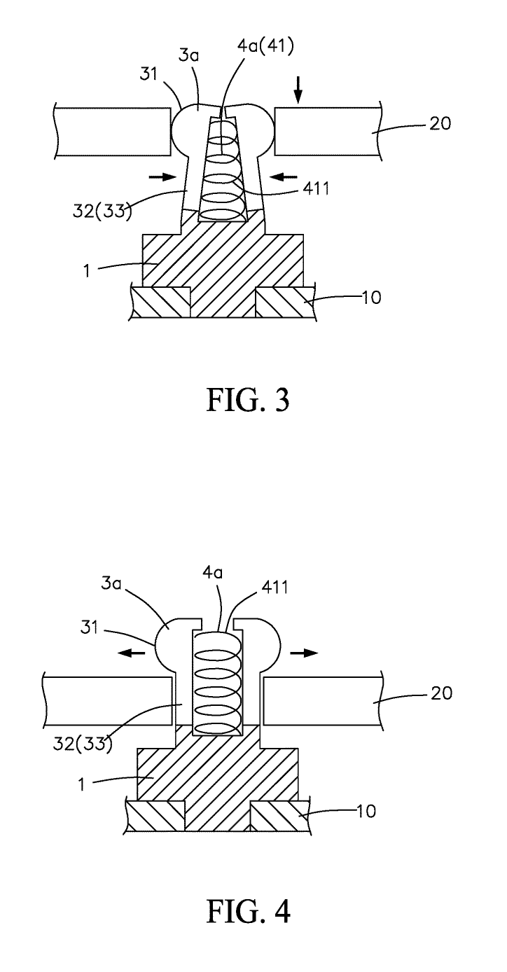

Referring to FIG. 1 and FIG. 2, the present invention provides a resilient fastener for being coupled to a first object 10 (such as a casing, chassis, plate or circuit board) and fastened to a second object 20 (such as another casing, chassis, plate or circuit board) to serve a quick fastening purpose. In a preferred first specific embodiment of the present invention, the resilient fastener comprises a body portion 1 coupled to the first object 10. The body portion 1 is provided in the form of a post, a rod, a plate, or a polyhedron. In particular, the body portion 1 has a mounting portion 2. The mounting portion 2 is provided in the form of a receiving opening 21 (such as a recess or a via) parallel to, perpendicular to, not parallel to, not perpendicular to, longitudinal relative to, or transverse relative to the post, rod, plate, or polyhedron. The resilient fastener further comprises a resilient fastening portion 3a is integrally formed or disposed at the body portion 1. The resilient fastening portion 3a protrudes from the body portion 1 and thus is fastened to the second object 20. The resilient fastener further comprises an elastic portion 4a disposed in the receiving opening 21 of the mounting portion 2 such that the elastic portion 4a exerts an elastic force on the resilient fastening portion 3a. The resilient fastening portion 3a contracts when compressed by the second object 20 (as shown in FIG. 3). After the second object 20 has passed the resilient fastening portion 3a, the elastic portion 4a pushes the resilient fastening portion 3a resiliently (as shown in FIG. 4), and in consequence the resilient fastening portion 3a gets fastened to a fastening hole of the second object 20. Therefore, the resilient fastener of the present invention fastens the first object 10 and the second object 20 together quickly.

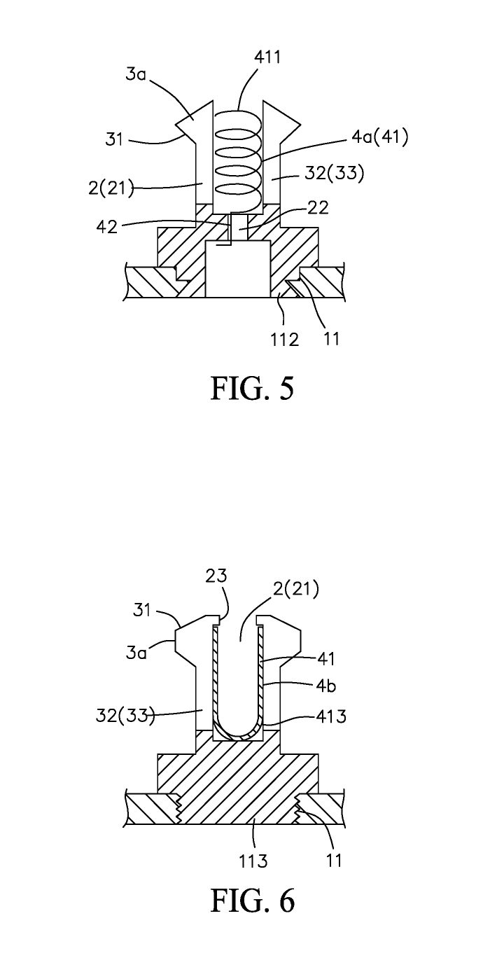

Referring to FIG. 1 and FIG. 2, the resilient fastening portion 3a is in the number of one or more, such as two, three, or preferably four as shown in the diagrams. As shown in the diagrams, the resilient fastening portions 3a each have a resilient fastening unit 32 integrally formed or coupled to one end of the body portion 1. Each resilient fastening unit 32 is a plate, a post or another structure. Slots 33 are formed between the resilient fastening units 32. The resilient fastening portion 3a is formed on the outer surface of the resilient fastening units 32. Specifically speaking, the resilient fastening portion 3 has a resilient fastening surface 31. The resilient fastening surface 31 is a spherical surface, an elliptic surface, or a curved surface. For example, the resilient fastening portion 3a is provided in the form of a sphere, an ellipse, or an arcuate solid such that the resilient fastening surface 31 is a spherical surface, an elliptic surface, or a curved surface, respectively. The resilient fastening surface 31 is also provided in the form of an oblique surface (as shown in FIG. 5) or a polygonal surface (as shown in FIG. 6), such as a V-shaped twin oblique surface or a trapezoidal polygonal surface. The elastic portion 4a is provided in the form of a standalone component, namely elastic component 41. The elastic component 41 is a spiral spring 411 (as shown in FIG. 1), a leaf spring 413 (as shown in FIG. 6), a resilient post 412 (as shown in FIG. 9), or a bent spring. The spiral spring 411, leaf spring 413, resilient post 412, or bent spring has an elastic end for acting on the resilient fastening portion 3a; hence, the elastic portion 4a (the elastic component 41) pushes the resilient fastening portion 3a resiliently and thus gets fastened to the second object 20.

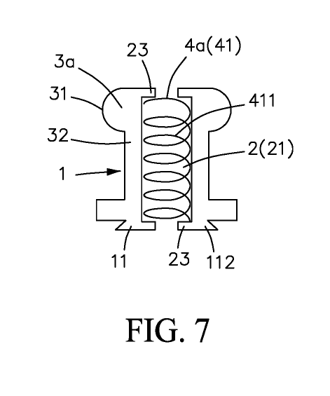

Referring to FIG. 5, a restrictive fastening portion 42 is disposed at one end or another selected portion of the elastic portion 4a (the elastic component 41) and coupled to the body portion 1 or the receiving opening 21 of the mounting portion 2. As shown in the diagram, the restrictive fastening portion 42 is a hook. The receiving opening 21 of the mounting portion 2 has a corresponding fastening portion 22 which the restrictive fastening portion 42 is hooked to, thereby fixing the elastic component 41 in place. Referring to FIG. 1 and FIG. 6, the mounting portion 2 has a stop portions 23 for restricting the elastic portion 4a (the elastic component 41). For instance, a necking stop portion 23 is disposed at the opening end of the receiving opening 21 to confine the elastic portion 4a (the elastic component 41) to the receiving opening 21 of the mounting portion 2. The stop portion 23 is disposed at one end (or two ends, the upper end, the lower end or a lateral side) of the elastic portion 4a. Referring to FIG. 7, not only is a necking stop portion 23 disposed at the opening end of the receiving opening 21 of the mounting portion 2, but a necking stop portion 23 is also disposed at the opening end attributed to the receiving opening 21 of the mounting portion 2 and positioned proximate to a coupling portion 11 such that the stop portions 23 can be located at two ends (or the upper end and lower end) of the elastic portion 4a, respectively.

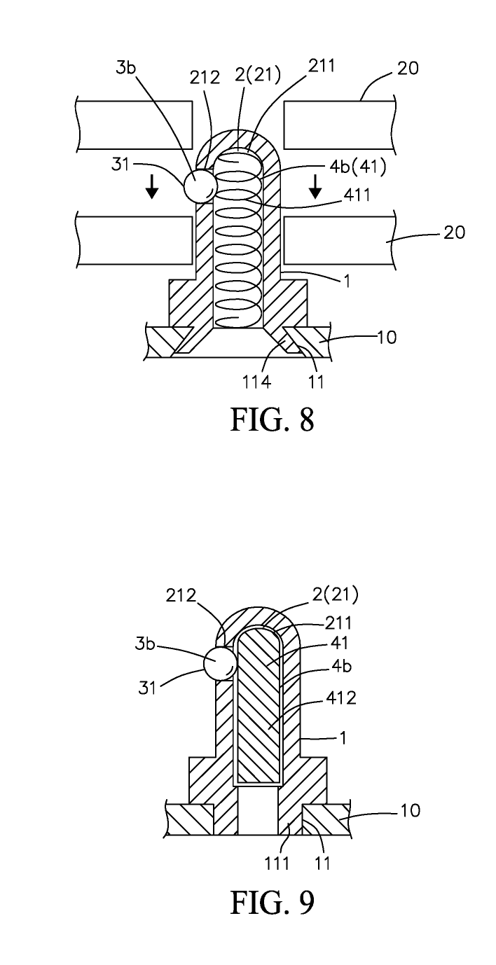

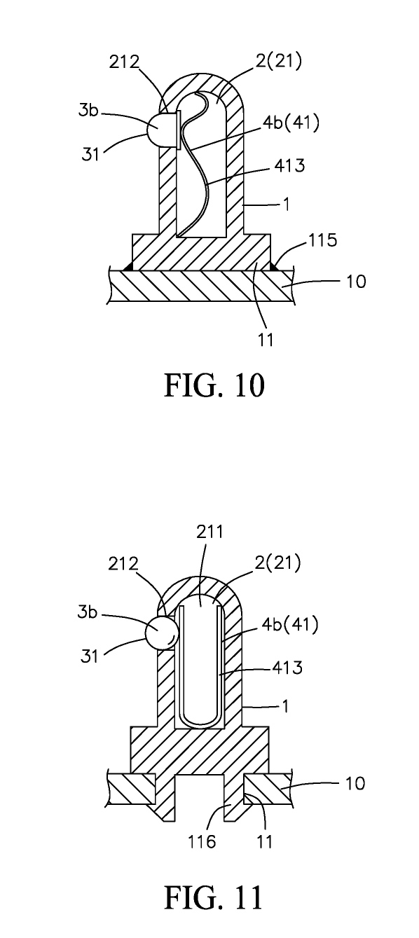

Referring to FIG. 1, in a preferred embodiment of the present invention, the resilient fastener is characterized in that an integrally formed or compositely formed coupling portion 11 is disposed at one end of the body portion 1. The body portion 11 is coupled to the first object 10 through the coupling portion 11. The coupling portion 11 is coupled to the first object 10 through a posting structure 111 (as shown in FIG. 1), a riveting structure 112 (as shown in FIG. 5), a screwing structure 113 (as shown in FIG. 6), an expanding structure 114 (as shown in FIG. 8), a welding structure 115 (as shown in FIG. 10), a fastening structure 116 (as shown in FIG. 11), an adhering structure, a magnetic attraction, surface-mount technology (SMT) or an integrally formed structure, and thus the resilient fastener of the present invention is coupled to the first object 10 to form a module. Hence, the first object 10 is quickly fastened to the second object 20 by the resilient fastener of the present invention.

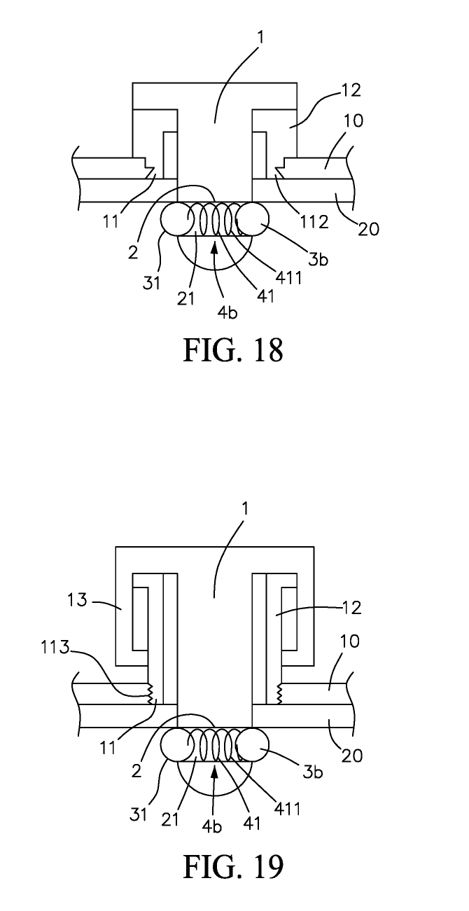

Referring to FIG. 18, the resilient fastener of the present invention comprises a sleeve 12 movably fitted around the body portion 1 or confined to the body portion 1. The bottom of the sleeve 12 has the coupling portion 11 for being coupled to the first object 10. Hence, the resilient fastener of the present invention enables the sleeve 12 to be coupled to the first object 10 and then enables the first object 10 to be fastened to the second object 20 through the resilient fastening portion 3b.

Referring to FIG. 19, the resilient fastener of the present invention comprises a sleeve 12 of a cap 13 movably fitted around the body portion 1 or confined to the body portion 1. A retracted flange is disposed at the bottom of the cap 13. An outward-extending flange is disposed at the top of the sleeve 12. The outward-extending flange of the sleeve 12 is movably confined to the retracted flange of the cap 13. Disposed on the bottom of the sleeve 12 is the coupling portion 11 for being coupled to the first object 10. Accordingly, the resilient fastener of the present invention enables the sleeve 12 to be coupled to the first object 10 and then enables the first object 10 to be fastened to the second object 20 through the resilient fastening portion 3b.

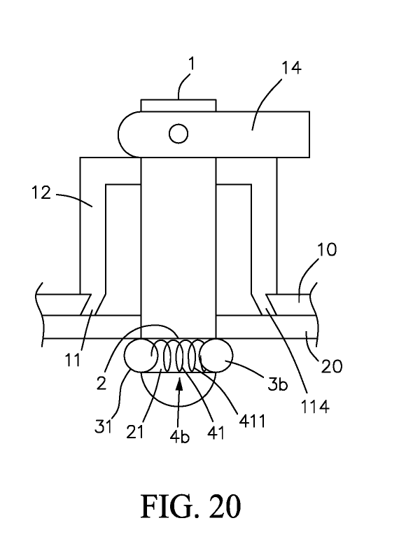

Referring to FIG. 20, the resilient fastener of the present invention comprises a sleeve 12 movably fitted around the body portion 1 or confined to the body portion 1, and a wrench 14 disposed outside the sleeve 12 to pivotally connect with the body portion 1 or abut against the sleeve 12. One end of the body portion 1 movably protrudes from the sleeve 12 to pivotally connect with the wrench 14. The wrench 14 abuts against the point at which the body portion 1 protrudes from the sleeve 12. Disposed at the bottom of the sleeve 12 is the coupling portion 11 for being coupled to the first object 10. The distance from the point of pivotal connection between the wrench 14 and the body portion 1 to the abutting end surface of the wrench 14 differs from (or equals) the distance from the point of pivotal connection between the wrench 14 and the body portion 1 to the abutting lateral surface of the wrench 14. Accordingly, the resilient fastener of the present invention enables the sleeve 12 to be coupled to the first object 10 and then enables the first object 10 to be fastened to the second object 20 through the resilient fastening portion 3b. The resilient fastener of the present invention is further characterized in that the wrench 14 drives the resilient fastening portion 3b to get fastened to or separate from the second object 20.

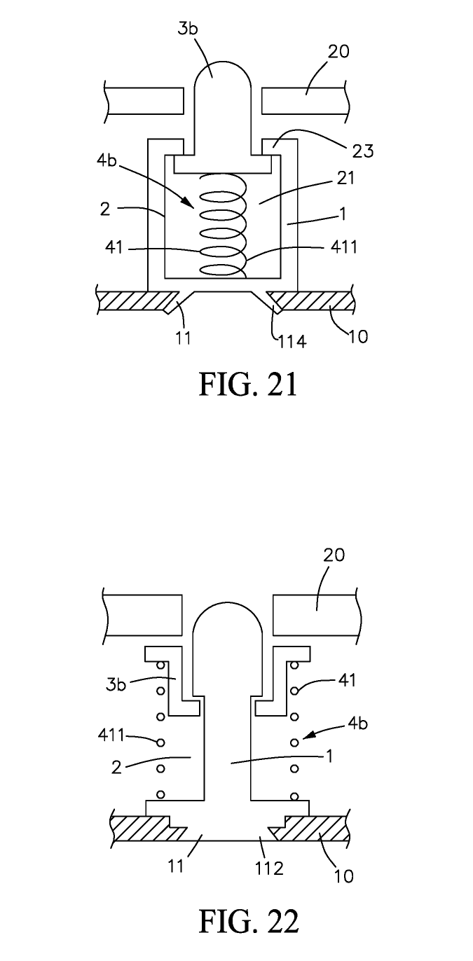

Referring to FIG. 21, regarding the resilient fastener of the present invention, the resilient fastening portion 3b not only gets fastened to or separate from the second object 20 by a transverse motion but also gets fastened to or separate from the second object 20 by a longitudinal motion. For instance, the resilient fastening portion 3a is removed from the resilient fastener shown in FIG. 1 to bring what is shown in FIG. 21: the resilient fastening portion 3b is disposed on the elastic portion 4a in the mounting portion 2, stopped by the stop portions 23, and fastened to or separated from the second object 20 by a longitudinal motion.

Referring to FIG. 22, regarding the resilient fastener of the present invention, the mounting portion 2 is not only disposed in the body portion 1 in the aforesaid way but also disposed outside the body portion 1. The resilient fastening portion 3b is a sleeve movably fitted around the body portion 1 and movably confined to the outside of the body portion 1. An elastic portion 4b is the spiral spring 411 movably fitted around the body portion 1 and abuttingly disposed between the body portion 1 and the resilient fastening portion 3b. Accordingly, the resilient fastener of the present invention is characterized in that: the coupling portion 11 of the body portion 1 gets coupled to the first object 10, and then the first object 10 gets fastened to the second object 20 through the free end of the body portion 1 and the resilient fastening portion 3b.

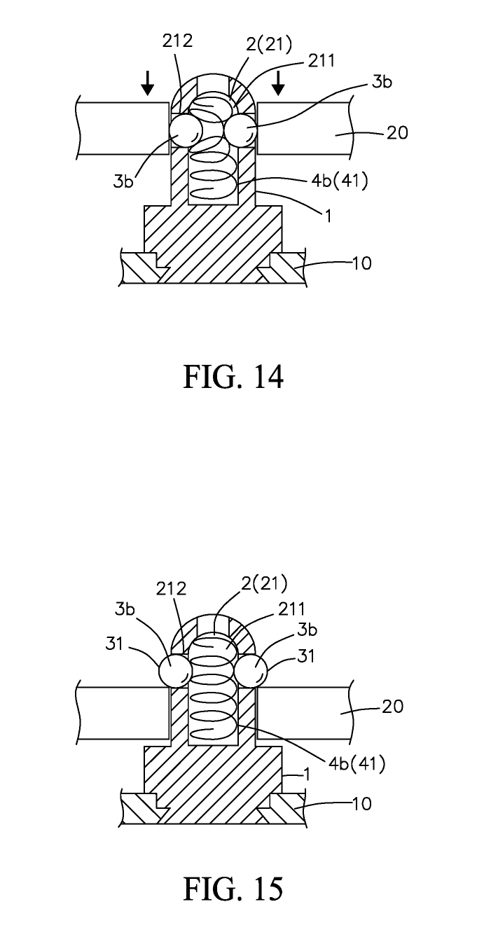

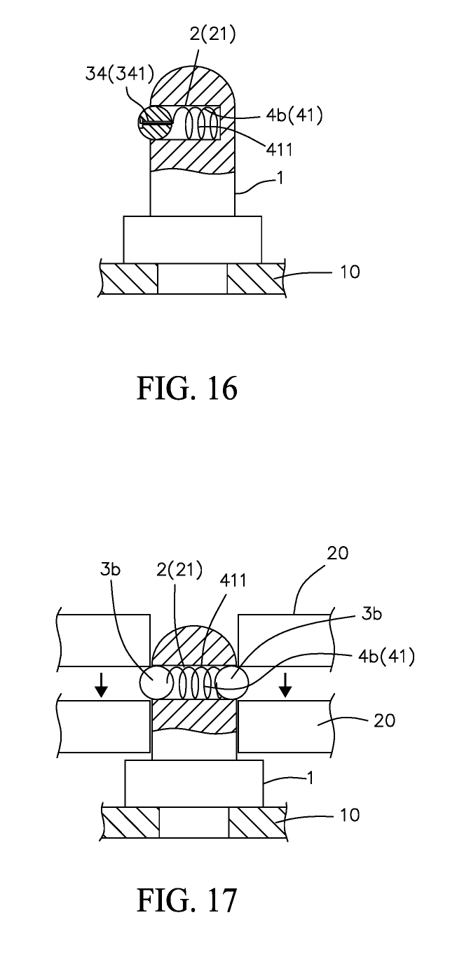

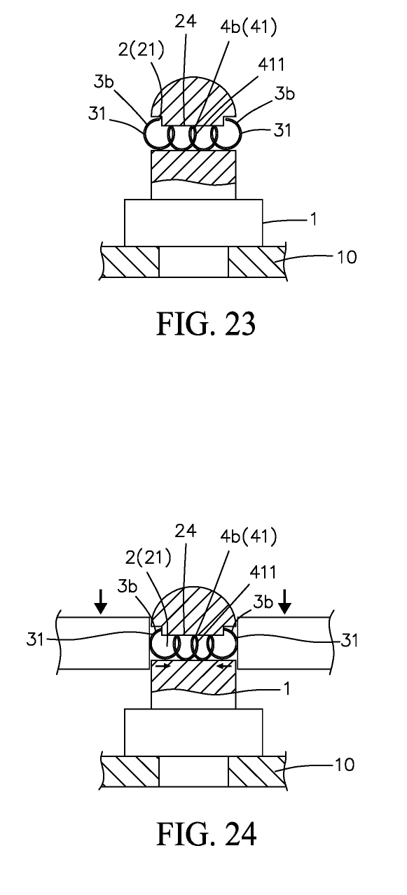

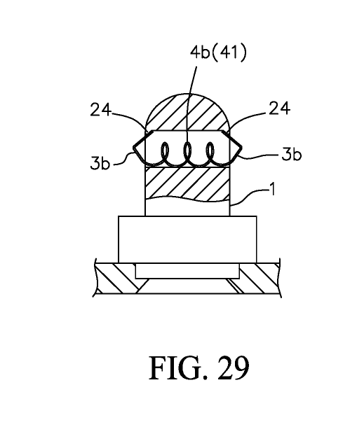

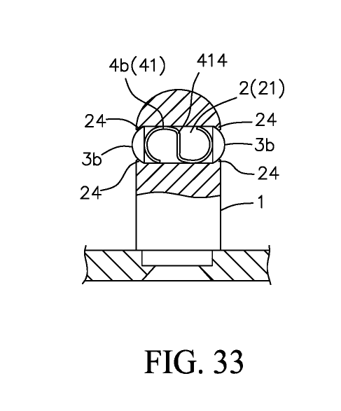

Referring to FIG. 8 through FIG. 15, FIG. 16 through FIG. 17, and FIG. 23 through FIG. 28, the resilient fastener in the second specific embodiment of the present invention is coupled to a first object 10 (such as a casing, chassis, plate or circuit board) and fastened to a second object 20, preferably comprising a body portion 1 coupled to the first object 10. The body portion 1 is provided in the form of a post, a rod, a plate, or a polyhedron. In particular, the body portion 1 has a mounting portion 2. The mounting portion 2 is provided in the form of the receiving opening 21 (such as a recess or a via) parallel to, perpendicular to, not parallel to, not perpendicular to, longitudinal relative to, or transverse relative to the post, rod, plate, or polyhedron. Referring to FIG. 8 through FIG. 15, the receiving opening 21 is axially parallel to the body portion 1. Referring to FIG. 16 through FIG. 17 or FIG. 23 through FIG. 28, the receiving opening 21 is either radially concave when disposed at, or penetrates, the body portion 1, whereas the receiving opening 21 or the body portion 1 (as shown in FIG. 29 and FIG. 33) has a restrictive portion 24 which protrudes from or retracts into the inner wall or the opening of the receiving opening 21 to restrict an elastic portion 4b or a resilient fastening portion 3b. The elastic portion 4b is disposed in the receiving opening 21 of the mounting portion 2. A resilient fastening portion 3b is disposed at one end portion or two end portions of the elastic portion 4b and protruded from the body portion 1 so as to be fastened to the second object 20. Accordingly, the elastic portion 4b exerts an elastic force on the resilient fastening portion 3b such that the resilient fastening portion 3b contracts when compressed by the second object 20 (as shown in FIG. 14). After the second object 20 has passed the resilient fastening portion 3b, the elastic portion 4b pushes the resilient fastening portion 3b resiliently (as shown in FIG. 8 or FIG. 15), and in consequence the resilient fastening portion 3b gets fastened to the fastening hole of the second object 20. Therefore, the resilient fastener of the present invention fastens the first object 10 and the second object 20 together quickly.

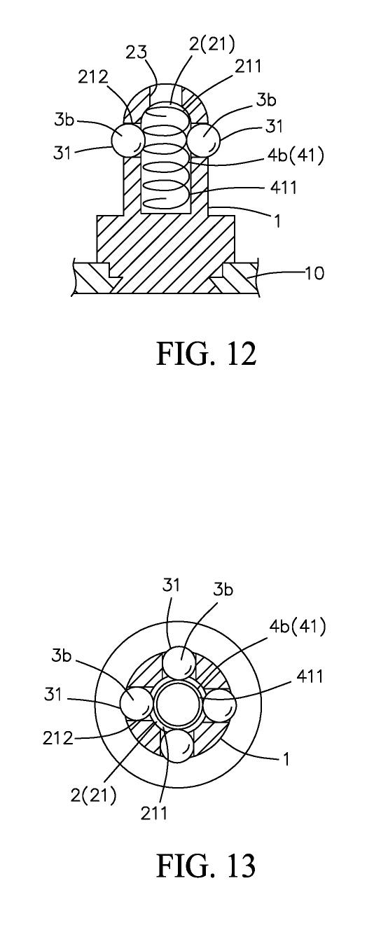

Referring to FIG. 8 through FIG. 11, in the second preferred embodiment, the receiving opening 21 of the body portion 1 has a first receiving opening 211 axially parallel to the body portion 1 and one, two or more second receiving openings 212 (which are preferably provided in the number of four as shown in FIG. 12 and FIG. 13.) Each second receiving opening 212 extends from one side of the body portion 1 to radially communicate with the first receiving opening 211. The elastic portion 4b is the elastic component 41 which is a standalone component placed in the first receiving opening 211. The resilient fastening portion 3b is a fastener which is a standalone component placed in each second receiving opening 212. Specifically speaking, the elastic portion 4b (the elastic component 41) is provided in the form of a spiral spring 411 (as shown in FIG. 8), a resilient post 412 (as shown in FIG. 9), a leaf spring 413 (as shown in FIG. 10 and FIG. 11) or a bent spring 414 (as shown in FIG. 26 or FIG. 33). The resilient fastening portion 3b is provided in the form of a fastener which also has a resilient fastening surface 31. The resilient fastening surface 31 is a spherical surface, an elliptic surface, a curved surface, an oblique surface, or a polygonal surface, whereas the resilient fastening portion 3b is preferably provided in the form of a sphere. Accordingly, the elastic component 41 pushes the resilient fastening portion 3b such that, after the second object 20 has been compressed and passed the resilient fastening portion 3b (as shown in FIG. 8 and FIG. 14), the resilient fastening portion 3b gets fastened to the fastening hole of the second object 20 (as shown in FIG. 8 and FIG. 15).

Referring to FIG. 16 through FIG. 17 or FIG. 23 through FIG. 28, in the second preferred embodiment, at least one receiving opening 21 of the body portion 1 is radially perpendicular to the body portion 1. The receiving opening 21 is a concave hole (as shown in FIG. 16 and FIG. 28) or a penetrating hole (as shown in FIG. 17 and FIG. 23 through FIG. 27). The elastic portion 4b is the elastic component 41 which is a standalone component placed in the receiving opening 21, whereas the resilient fastening portion 3b is a fastener which is a standalone component placed in the receiving opening 21. Specifically speaking, the elastic portion 4b (the elastic component 41) is provided in the form of a spiral spring 411 (as shown in FIG. 16), a resilient post, a leaf spring, or another resilient mass, whereas the resilient fastening portion 3b is provided in the form of a fastener with a resilient fastening surface 31. The resilient fastening surface 31 is a spherical surface, an elliptic surface, a curved surface, an oblique surface, or a polygonal surface, but the resilient fastening portion 3b is preferably provided in the form of a sphere. Accordingly, the elastic component 41 pushes the resilient fastening portion 3b such that, after the second object 20 has been compressed and passed the resilient fastening portion 3b (as shown in FIG. 8 and FIG. 14), the resilient fastening portion 3b gets fastened to the fastening hole of the second object 20 (as shown in FIG. 8 and FIG. 15).

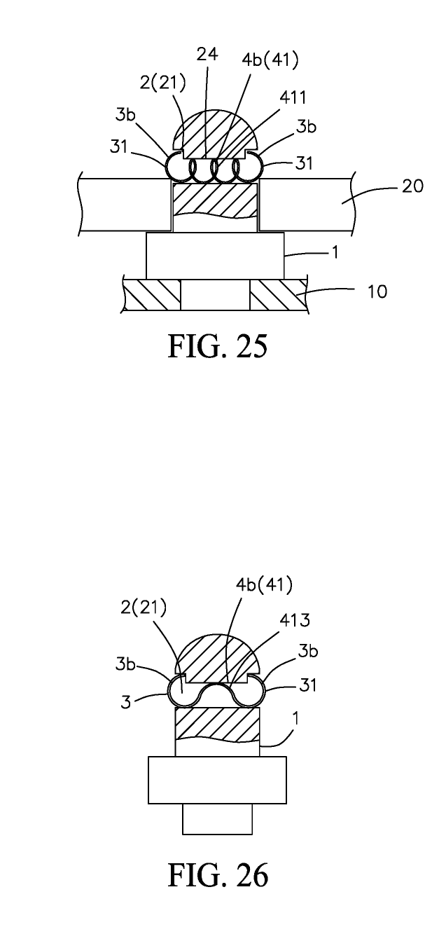

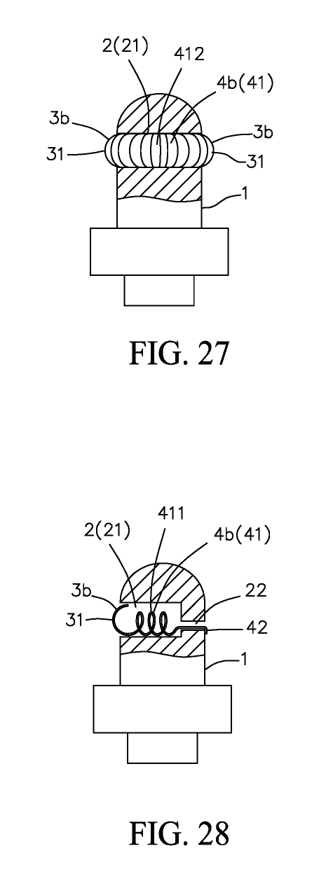

Referring to FIG. 23 through FIG. 27, the elastic portion 4b and the resilient fastening portion 3b are each provided in the form of an integrally formed standalone component. For instance, the elastic portion 4b is provided in the form of the elastic component 41. The elastic component 41 is a spiral spring 411 (as shown in FIG. 23 through FIG. 25), a leaf spring 413 (as shown in FIG. 26), or a resilient post 412 (as shown in FIG. 27), whereas the resilient fastening portion 3b is provided in the form of a fastener bent and integrally formed at one or two ends of the elastic component 41, wherein the fastener has a resilient fastening surface 31. The resilient fastening surface 31 is a spherical surface, an elliptic surface, a curved surface, an oblique surface, or a polygonal surface. Accordingly, the elastic component 41 pushes the resilient fastening portion 3b such that, after the second object 20 has been compressed and passed the resilient fastening portion 3b (as shown in FIG. 24), the resilient fastening portion 3b gets fastened to the fastening hole of the second object 20 (as shown in FIG. 25).

Referring to FIG. 23 and FIG. 26, the radially-extending receiving opening 21 or body portion 1 has a restrictive portion 24 which protrudes from or retracts into the inner wall or the opening of the receiving opening 21 to restrict the elastic portion 4b or the resilient fastening portion 3b. Referring to FIG. 28, a restrictive fastening portion 42 is disposed at one end or another selected portion of the elastic portion 4b (the elastic component 41) and coupled to the body portion 1 or the receiving opening 21 of the mounting portion 2. Referring to FIG. 28, the restrictive fastening portion 42 is a hook, whereas the receiving opening 21 of the mounting portion 2 has a corresponding fastening portion 22 which the restrictive fastening portion 42 is hooked to, thereby fixing the elastic component 41 in place.

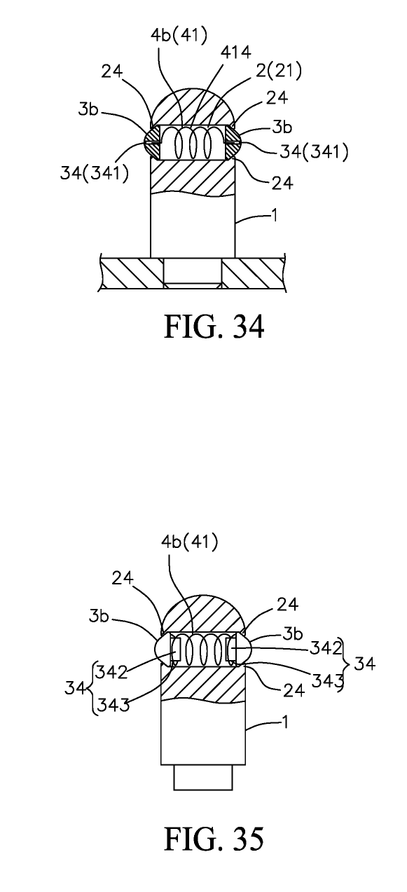

Referring to FIG. 16 or FIG. 34, according to the present invention, the resilient fastening portion 3b has a fixing portion 34 positioned at and coupled to the elastic portion 4b. The fixing portion 34 is coupled to the elastic portion 4b through a posting structure, a riveting structure, a screwing structure, an expanding structure, a welding structure, a fastening structure, an adhering structure, an sleeving structure, an abutting structure, a magnetic attraction, surface-mount technology (SMT), or an integrally formed structure. Specifically speaking, the fixing portion 34 is a through-hole 341 of the resilient fastening portion 3b, a sleeve, a post 342 (as shown in FIG. 35), a fastener, a step portion 343, or a plane portion such that the elastic portion 4b is inserted into and engaged with the through-hole 341 or is positioned at and coupled to the sleeve, post, or fastener. Referring to FIG. 35, the fixing portion 34 has the step portion 343 and post 342 which are positioned proximate to the resilient fastening portion 3b. The step portion 343 is disposed at the periphery of the post 342. One end of the elastic component 41 abuts against the step portion 343 and fits around the post 342.

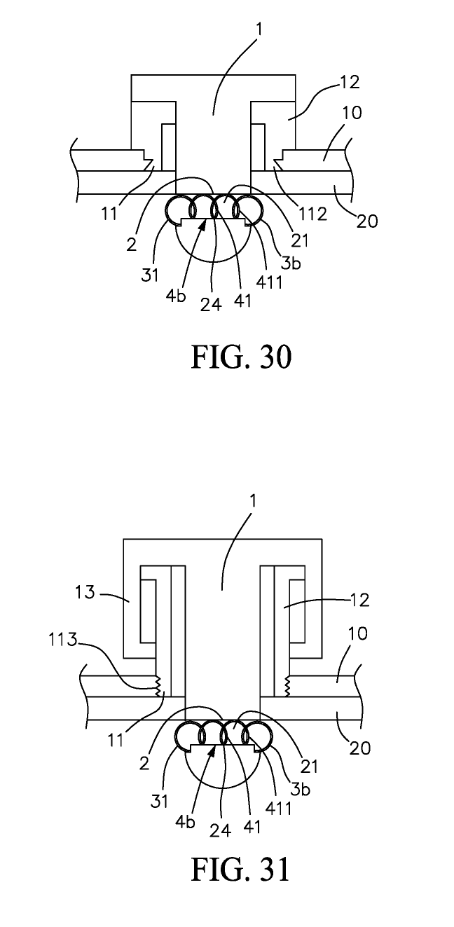

Referring to FIG. 30, according to the present invention, the resilient fastener comprises a sleeve 12 movably fitted around the body portion 1 or confined to the body portion 1, and disposed at the bottom of the sleeve 12 is the coupling portion 11 for being coupled to the first object 10. Accordingly, the resilient fastener of the present invention is characterized in that: the sleeve 12 gets coupled to the first object 10, and then the first object 10 gets fastened to the second object 20 through the resilient fastening portion 3b at the end portion of the elastic portion 4b.

Referring to FIG. 31, the resilient fastener of the present invention comprises a sleeve 12 of a cap 13 movably fitted around the body portion 1 or confined to the body portion 1. A retracted flange is disposed at the bottom of the cap 13. An outward-extending flange is disposed at the top of the sleeve 12. The outward-extending flange of the sleeve 12 is movably confined to the retracted flange of the cap 13. Disposed on the bottom of the sleeve 12 is the coupling portion 11 for being coupled to the first object 10. Accordingly, the resilient fastener of the present invention enables the sleeve 12 to be coupled to the first object 10 and then enables the first object 10 to be fastened to the second object 20 through the resilient fastening portion 3b disposed at the end portion of the elastic portion 4b.

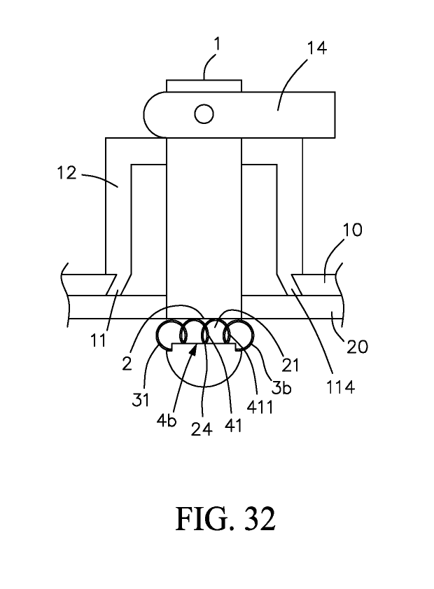

Referring to FIG. 32, the resilient fastener of the present invention comprises a sleeve 12 movably fitted around the body portion 1 or confined to the body portion 1 and a wrench 14 disposed outside the sleeve 12 to pivotally connect with the body portion 1 or abut against the sleeve 12. One end of the body portion 1 movably protrudes from the sleeve 12 to pivotally connect with the wrench 14. The wrench 14 abuts against the point at which the body portion 1 protrudes from the sleeve 12. Disposed at the bottom of the sleeve 12 is the coupling portion 11 for being coupled to the first object 10. The distance from the point of pivotal connection between the wrench 14 and the body portion 1 to the abutting end surface of the wrench 14 differs from (or equals) the distance from the point of pivotal connection between the wrench 14 and the body portion 1 to the abutting lateral surface of the wrench 14. Accordingly, the resilient fastener of the present invention enables the sleeve 12 to be coupled to the first object 10 and then enables the first object 10 to be fastened to the second object 20 through the resilient fastening portion 3b disposed at the end portion of the elastic portion 4b. Furthermore, the resilient fastener of the present invention is further characterized in that the wrench 14 drives the resilient fastening portion 3b disposed at the end portion of the elastic portion 4b to get fastened to or separate from the second object 20.

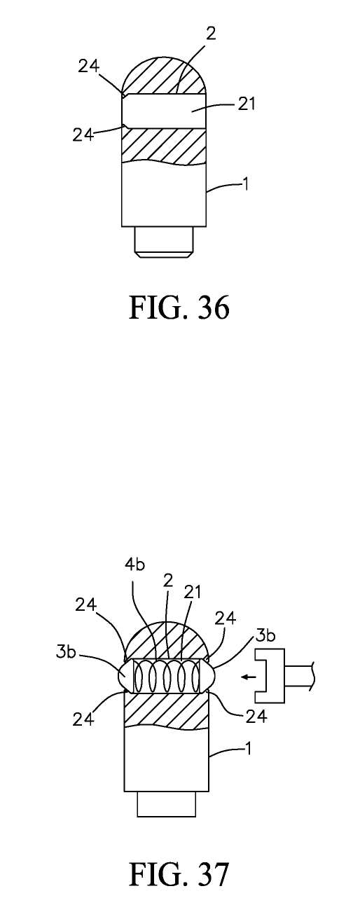

The present invention further provides a method of forming the restrictive portion 24 of the resilient fastener. The method essentially comprises the steps as follows: (a) forming the restrictive portion 24 disposed at one end of the receiving opening 21 of the mounting portion 2 with a lathe by a cutting process or with a milling machine by a pressing process to allow the receiving opening 21 to form a stop structure, as shown in FIG. 36; (b) placing components of the resilient fastening portion 3b and components of the elastic portion 4b and then performing a pressing process at another end to form the restrictive portion 24 at the other end such that both the resilient fastening portion 3b and the elastic portion 4b are confined to between the two restrictive portions 24, as shown in FIG. 37.

The present invention is disclosed above by preferred embodiments. However, persons skilled in the art should understand that the preferred embodiments are illustrative of the present invention only, but should not be interpreted as restrictive of the scope of the present invention. Hence, all equivalent variations and replacements made to the aforesaid embodiments should fall within the scope of the present invention. Accordingly, the legal protection for the present invention should be defined by the appended claims.

What is claimed is:

1. A resilient fastener, coupled to a first object and fastened to a second object, comprising: a body portion coupled to the first object and having a mounting portion; a resilient fastening portion integrally or compositely formed at the body portion and protruded from the body portion to get fastened to the second object; and an elastic portion disposed at the mounting portion and adapted to exert an elastic force on the resilient fastening portion pushed resiliently by the elastic portion when the resilient fastening portion is compressed.

2. The resilient fastener of claim 1, wherein the body portion is one of a post, a rod, a plate, and a polyhedron, and the mounting portion is a receiving opening parallel to, perpendicular to, not parallel to, not perpendicular to, longitudinal relative to, or transverse relative to the one of the post, the rod, the plate, and the polyhedron.

3. The resilient fastener of claim 1, wherein the resilient fastening portion has a resilient fastening unit integrally formed with the body portion, with the resilient fastening portion formed on an outer surface of the resilient fastening unit.

4. The resilient fastener of claim 1, wherein the resilient fastening portion has a resilient fastening surface, with the resilient fastening surface being one of a spherical surface, an elliptic surface, a curved surface, an oblique surface, and a polygonal surface.

5. The resilient fastener of claim 1, wherein the elastic portion has a restrictive fastening portion coupled to one of the body portion, the mounting portion, and a corresponding fastening portion of the mounting portion.

6. The resilient fastener of claim 1, wherein the mounting portion has stop portions for restricting the elastic portion.

7. The resilient fastener of claim 1, further comprising a coupling portion integrally or compositely formed at the body portion and coupled to the first object through one of posting, riveting, screwing, expanding, welding, fastening, adhering, magnetic attraction, surface-mount technology (SMT), and integral forming.

8. The resilient fastener of claim 1, further comprising a sleeve movably fitted around or confined to the body portion and coupled to the first object.

9. The resilient fastener of claim 1, further comprising a sleeve of a cap movably fitted around the body portion or confined to the body portion, with the sleeve coupled to the first object.

10. The resilient fastener of claim 1, further comprising a sleeve movably fitted around or confined to the body portion, and a wrench disposed outside the sleeve to pivotally connect with the body portion or abut against the sleeve, with the sleeve coupled to the first object, wherein a distance from a point of pivotal connection between the wrench and the body portion to an abutting end surface of the wrench differs from or equals a distance from the point of pivotal connection between the wrench and the body portion to an abutting lateral surface of the wrench.

11. The resilient fastener of claim 1, wherein the mounting portion is disposed outside the body portion, and the resilient fastening portion is movably disposed outside the body portion.

12. A resilient fastener, coupled to a first object and fastened to a second object, comprising: a body portion coupled to the first object and having a mounting portion; an elastic portion mounted on the mounting portion and having an end provided with a resilient fastening portion, wherein, to be fastened to the second object, the resilient fastening portion protrudes from the body portion by being compressed and thus resiliently pushed by the elastic portion.

13. The resilient fastener of claim 12, wherein the body portion is one of a post, a rod, a plate, and a polyhedron, and the mounting portion is a receiving opening parallel to, perpendicular to, not parallel to, not perpendicular to, longitudinal relative to, or transverse relative to the one of the post, the rod, the plate, and the polyhedron.

14. The resilient fastener of claim 13, wherein one of the receiving opening and the body portion has at least one restrictive portion protruding from or retracting into one of an inner wall and an opening of the receiving opening to restrict one of the elastic portion and the resilient fastening portion.

15. The resilient fastener of claim 12, wherein the mounting portion comprises a first receiving opening parallel to the body portion and at least one second receiving opening extending from a side of the body portion to radially communicate with the first receiving opening, wherein the elastic portion is disposed at the first receiving opening, and the resilient fastening portion is disposed at the second receiving opening.

16. The resilient fastener of claim 12, wherein the elastic portion is a standalone elastic component, and the resilient fastening portion is a standalone fastener.

17. The resilient fastener of claim 12, wherein the resilient fastening portion has a resilient fastening surface, with the resilient fastening surface being one of a spherical surface, an elliptic surface, a curved surface, an oblique surface, and a polygonal surface.

18. The resilient fastener of claim 12, wherein the elastic portion has a restrictive fastening portion coupled to one of the body portion and the mounting portion.

19. The resilient fastener of claim 12, further comprising a coupling portion integrally or compositely formed at the body portion and coupled to the first object through one of posting, riveting, screwing, expanding, welding, fastening, adhering, magnetic attraction, surface-mount technology (SMT), and integral forming.

20. The resilient fastener of claim 12, wherein the resilient fastening portion has a fixing portion positioned at and coupled to an end of the elastic portion.

21. The resilient fastener of claim 20, wherein the fixing portion has one of a through-hole, a sleeve, a post, a fastener, a step portion, and a plane portion.

22. The resilient fastener of claim 12, further comprising a sleeve movably fitted around or confined to the body portion and coupled to the first object.

23. The resilient fastener of claim 12, further comprising a sleeve of a cap movably fitted around the body portion or confined to the body portion, with the sleeve coupled to the first object.

24. The resilient fastener of claim 12, further comprising a sleeve movably fitted around or confined to the body portion, and a wrench disposed outside the sleeve to pivotally connect with the body portion or abut against the sleeve, with the sleeve coupled to the first object, wherein a distance from a point of pivotal connection between the wrench and the body portion to an abutting end surface of the wrench differs from or equals a distance from the point of pivotal connection between the wrench and the body portion to an abutting lateral surface of the wrench.
